(19) United States
(12) Patent Application Publication
(10) Pub. No.: US 2006/0247969 A1
(43) Pub. Date: Nov. 2, 2006

(54) Marketing system and method

(76) Inventor: Herbert Dale Yates JR., Maineville, OH (US)

Correspondence Address: FROST BROWN TODD, LLC, 2200 PNC CENTER, 201 E. FIFTH STREET, CINCINNATI, OH, 45202, US

(21) Appl. No.: 11/342,933

(22) Filed: Jan. 30, 2006

Related U.S. Application Data
(63) Continuation-in-part of application No. 11/118,640, filed on Apr. 29, 2005.

(51) Int. Cl. G06Q 30/00

(52) U.S. Cl. 705/14

(57) ABSTRACT

A system and method for marketing goods and services by providing coupons having multiple identifiers, such as double branding and/or datastore identifiers, to consumers. The double branded coupons may be distributed freely to consumers by a first provider, where the consumer may redeem the coupon from a second provider. The second provider may give the first provider compensation for the distribution of coupons bearing their identifier.

### RELATED APPLICATIONS

This is a continuation-in-part of U.S. patent application Ser. No. 11/118,640, filed on Apr. 29, 2005.

### FIELD OF THE INVENTION

The present invention relates, in general, to marketing goods and/or services and, more particularly, to coupons that are double branded and may be automatically redeemed.

### BACKGROUND

The use of basic coupons has long been a part of commerce. Typically, a discount or benefit to a consumer will be offered in the form of a paper slip that may be provided to the consumer via the mail, newspapers, or the like. This coupon will generally bear the name of the party that will accept the coupon and the offer or discount that the customer could expect to receive. Often, the redemption of the coupon will be conditional upon the consumer selecting and purchasing a particular item. Discount coupons are distributed for a variety of reasons including, for example, to publicize new products, to diminish stocks of dated products, or to encourage buyers to select a particular store or provider for future purchases.

Gift cards bearing the names of retail chains such as LOWES and WAL-MART have also been available to consumers for some time. These gift cards are generally purchased by one consumer for value and are then given to a second consumer as, for example, a holiday gift. The gift card will frequently inform the consumer of the location or retailer at which the card may be redeemed and the value of the card. Retailers encourage the sales of gift cards because, frequently, individuals will spend more than the amount of the gift card at the store and may patronize the store in the future.

It would be advantageous to provide a marketing system and method that combined the benefits of both coupons and gift cards. It would be further advantageous to provide a marketing system and method that creates symbiotic relationships between multiple providers of goods and services.

### DESCRIPTION OF DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 is an oblique view of one embodiment of a reusable storage container.

FIG. 2 is a schematic representation of an example of a reusable storage container distribution and rental system.

FIG. 3 and FIG. 4 are block diagrams of a representative arrangement of an example of a reusable storage container method.

FIG. 5 illustrates an example of a promotion.

FIG. 6 illustrates some examples of coupon and commission systems and methods.

FIG. 7 illustrates an example of a promotional display.

FIG. 8 illustrates an example of a debit card coupon.

The drawing and detailed description which follow are intended to be merely illustrative and are not intended to limit the scope of the invention as set forth in the appended claims.

### DETAILED DESCRIPTION

In one version, a system and method allows an individual customer to rent or optionally purchase one or more reusable storage containers located at various outlets. It will be appreciated that the reusable storage containers are disclosed by way of example only and are not intended to be limiting, where versions of the system and method disclosed may be applied to any suitable good and/or service.

It will be understood that any type of reusable storage container may be utilized that can be used to store a variety of different articles. For example, the containers may be used to store items such as china, dishes, video cassette tapes, compact discs, DVDs, jewelry, clothing, books, paper, furniture, small appliances, or the like. Indeed, the type and variety of articles is virtually unlimited.

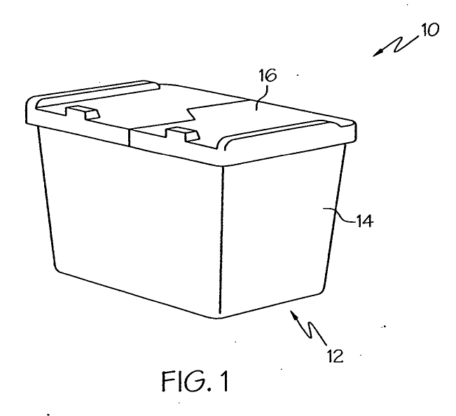

FIG. 1 illustrates one example of a reusable storage container (10). As shown in this example, the reusable storage container (10) comprises a bottom (12), side walls (14), and a cover (16). The bottom (12) in this example is rectangular, however, a variety of other shapes may also be employed, including, but not limited to, circular, triangular, square, polyhedral, or the like. The overall shape of the reusable storage container (10) may vary according to the specific needs of the customer, and the containers are available in a cube shape, tetrahedron, octahedron, or any other polyhedronic shape.

The containers may also be available in a variety of different shapes and sizes. For example, in one embodiment, rectangular-shaped reusable storage containers (10) are available in sizes small (approximately 22×16×12.5 inches), medium (approximately 24×20×12.5 inches), and large (approximately 24×24×24 inches). In one embodiment, the containers are large walk-in storage units.

The reusable storage container (10) of this example is made of a commercial grade plastic material such as a polypropylene, polyethylene, fiberglass, wood pulp, resins, plastic compositions, or the like. Without limitation and by way of example, other suitable materials include metal, wood, cardboard, and the like. Examples of commercial grade plastic materials available for construction of the reusable storage container include but are not limited to those specified above. The containers may be water resistant, such that the contents are protected from water seeping in and damaging the contents or damaging the container. Additionally, the bottom (12), side walls (14), and cover (16) may be fireproof or have UV-protectant characteristics.

One advantage of a reusable storage container (10) is that it is environmentally friendly because of the reusable nature. Further, such containers (10) may be recyclable when their useful life is over as a storage device.

In another variation, the reusable storage containers (10) are available in various colors, hues and degrees of transparency. This will allow for coordinated storage and/or easy identification of particular articles in the reusable storage containers (10). For example, financial documents may be stored in green colored containers, and china or dishes could be stored in a container displaying a bright shade of yellow. In addition, a transparent or semi-transparent wall (14) or cover (16) allows one to view the contents without having to open the container (10).

The reusable containers (10) optionally have removable, adjustable identification (ID) cards or tags (11) attachable to the side wall (14) or cover (16) of the reusable storage container (10). These identification means (11) will provide for easy identification of the contents of the containers and the labels are designed for simple change as new items are inserted into the container. The containers (10) may also have serial numbers or bar codes attached for simplified tracking.

In the present example, the cover (16) of the reusable storage container (10) is hingedly attached; however, snap-on lids are also contemplated. Optionally, this lid (16) is designed to allow the containers (10) to be stacked on top of one another with the lower container lid holding in place the container on top of it. The reusable storage container covers (16) may be made of the same or different material than the side wall(s) (14) and bottom (12).

Optionally, the reusable storage container (10) may be lockable with a pad lock or with plastic tie wraps (18). The tie wraps are contemplated as included in the rental agreement, for instance, as a one-time purchase.

While the foregoing are given as examples of certain options and customer specific choices for the reusable storage containers (10), it will be understood that other colors, materials and sizes are available according to the particular storage needs of the customer (28). It will further be understood that other types of materials are contemplated where advantageous performance may be varied from the foregoing teaching.

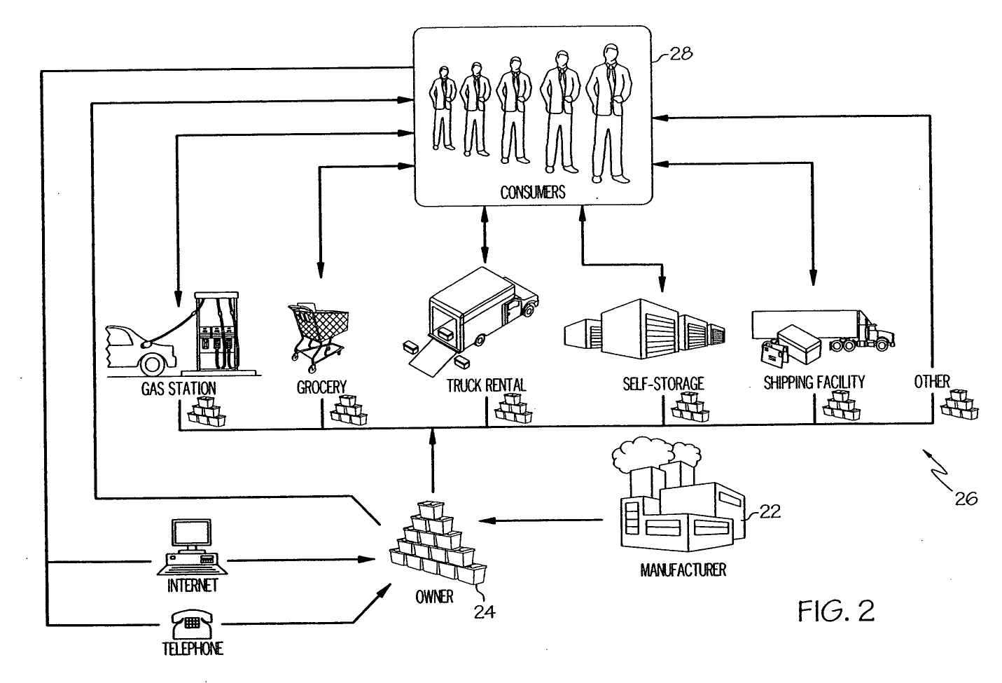

As schematically shown in FIG. 2, an embodiment of the present invention utilizes a manufacturer (22), an owner (24), a fulfillment center (25), and outlets (26), interacting with customers (28) seeking to obtain reusable storage containers (10) for a period of time. The customer (28) may be an individual renting in their personal capacity or as part of a business or organization. The customer (28) that is interested in obtaining one or more of the reusable storage containers (10) may contact the owner directly, via the telephone (for example, with a toll free number), by facsimile, or over the Internet (World Wide Web). Alternatively, the customer (28) may go to a fulfillment center (25), or an authorized outlet (26) and place an order, as described below in detail.

The method optionally begins with the manufacturer (22) producing reusable storage containers (10) and the owner (24) initially taking title to and/or control of a plurality of the reusable storage containers (10) from the manufacturer (22). It should be recognized, however, that the owner (24) may or may not take physical possession of the reusable storage containers (10) during the process of gaining control of the containers. It should be further recognized that the manufacturer (22) and the owner (24) could be one in the same.

The owner will then contract with a number of fulfillment centers (25) (optionally two to four) strategically located in different areas of a city. As a part of the contract, the owner (24) arranges for a monthly fee to be paid to the centers (25) for allowing owner's customers (28) to drop off and pick up containers (10) at the fulfillment centers (25). Optimally, the location of the fulfillment centers (25) will mean that ninety (90) percent of the population of the suburbs of a city will not be required to drive more than ten to fifteen minutes travel time to the drop off and pick up points, or fulfillment centers (25).

The fulfillment center (25) then receives a portion of the owner's (24) reusable storage containers (10). Typically, the portion of the plurality of reusable storage containers (10) are displayed in designated areas within the center (25) so as to make them visually open and available to all customers (28) in the fulfillment center (25). At each location, a place for entering into the transaction will be designated. In the context of this invention, the fulfillment centers (25) may be, but are not limited to U-HAUL® or STORE ‘N’ LOCKS® type facilities.

The benefit to the fulfillment center (25) is not only the monetary compensation for the service they provide to the owner (24), but also the increased traffic from new container rental customers (28) should enhance the utilization of their traditional facilities and services.

In conjunction with the fulfillment center (25), the present invention optionally utilizes authorized distributors or outlets (26) in its method. These outlets (26) are provided to customers (28) in myriad strategically chosen physical locations throughout a given town. Examples of authorized outlets (26) include, but are not limited to grocery stores, hardware stores, convenience stores, gas stations, shipping facilities, truck rental facilities, self-storage facilities, apartment complexes, office complexes, and the like. The outlets (26), which may operate as separate entities from the fulfillment centers (25), or be one in the same, interact primarily with the fulfillment centers (25) as a primary source for the customers (28) to enter into the rental contracts with the owner.

Each of the authorized outlets (26) is organized and operates in a manner that allows them to be capable of offering for rent to customers one or more of the reusable storage containers (10) for a period of time, receiving a deposit for the reusable storage containers (10), and receiving rental payments from the customer (28).

The customer (28) fills out, and the authorized outlet (26) accepts an order form, then faxes, calls or e-mails the order to the owner (24) so that the rental arrangements may be formalized. The outlet (26) gives the customer a copy of the order which reserves for the customer (28) the quantity of storage containers (10) on their order. This also establishes a mutually satisfactory date. The owner (24) then notifies the fulfillment center (25) that a customer will be by to pick up an order on the agreed date.

If a customer (28) who has placed an order with an outlet (26) goes to the fulfillment center (25) for pickup on the scheduled day and the order cannot be filled, the customer (28) gets free delivery and pick up service by the owner (24), in addition to monetary type compensation (for example coupons) to apply to their order. While the authorized outlet (26) would not typically have inventory (10), it is possible for special arrangements to be made to have any authorized outlet (26) become a fulfillment center (25), if desired.

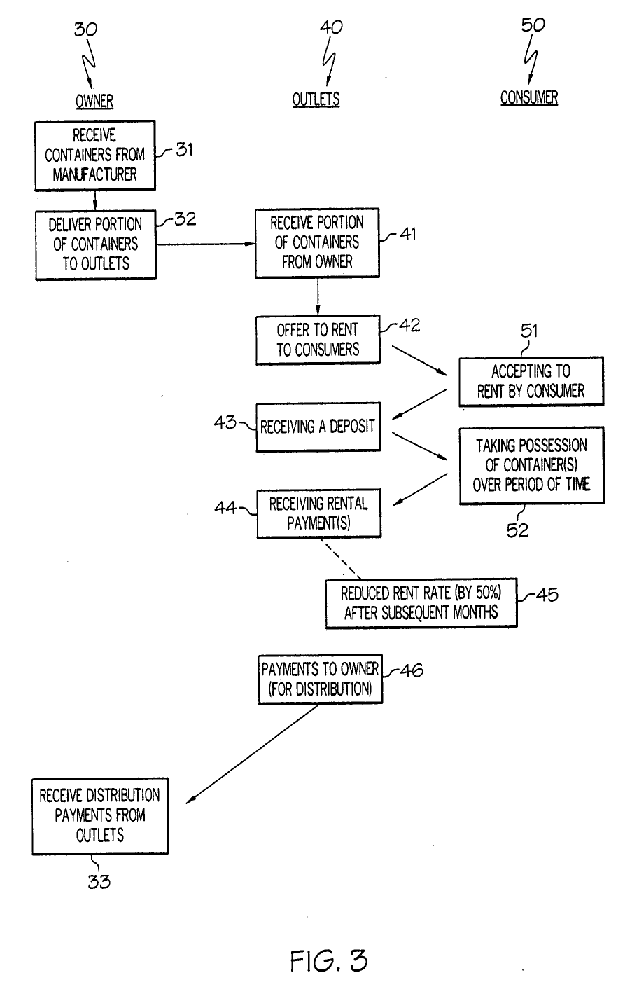

The block of steps (31-52) of FIG. 3, show the representative steps that occur with different embodiments of a method to rent and distribute storage containers, none of which are mutually exclusive of the other. The process optionally begins at step (31), when the owner (24) takes possession of a plurality of reusable storage containers (10) from the manufacturer (22). The owner (24), as shown in step (32), delivers a portion of the plurality of reusable storage containers to the fulfillment centers (25). During step (41), the fulfillment center (25) receives possession of the containers (10) and the owner (24) contracts with each fulfillment center (25) and arranges for a monthly fee to be paid by the owner (24) to the centers (25) for allowing owner's customers (28) to drop off and pick up containers (10) at the fulfillment centers (25).

The contract with the centers (25) provides that the owner (24) will pay a per transaction fee to the fulfillment center (25) for each order dropped off and picked up by the customer (28). At the conclusion of all transactions, the fulfillment center (25) collects full payment plus a deposit from the customer (28), which is received by owner (24) on a regular basis.

Further optionally, the fulfillment center (25) may rent the reusable storage containers (10) directly to customers (28), as shown in step (42), that come directly to their facility to place an order, rather than through the owner (24) or outlets (26). Additionally, the fulfillment center (25) may advertise and sell “delivered containers” (10), which the owner (24) will actually deliver to the customer (28) at their home, office, or other desired location. In this instance, the fulfillment center (25) will receive the same amount of compensation from the owner as an authorized outlet (26) would receive (described in detail below), plus the transaction fee for the direct sale, an shown in (step 44). Here, the delivery person would collect the balance of the rental as well as the deposit (step 43).

Alternatively, as depicted in step (52), a customer (28) has the option of taking the desired quantity of the reusable storage containers (10) with them following the culmination of the rental agreement transaction with the fulfillment center (25).

An embodiment of the present invention contemplates that each of the authorized outlets (26) is organized and operates in a manner that allows them to be capable of offering for rent (step 42) to customers one or more of the reusable storage containers for a period of time, receiving a deposit (step 43) for the reusable storage containers which were accepted by the customer, (at step 51), and receiving rental payments from the customer (step 44).

As detailed in step (46), the monthly fee (or commission) the fulfillment center (25) receives covers their service and operating costs as a fulfillment center (25).

Delivery of the reusable storage containers (10) may occur via the owner (24) after this contact with the authorized outlets (26), for those customers (28) who prefer to have the containers (10) delivered to them (and picked up when they are finished using them). If this option is chosen, the customer (28) will pay (and the owner (24) receive) a fee payment for the delivery. Additionally, a pickup fee paid to the owner (24) is contemplated, for the customer (28) that would like for the packed and filled reusable storage containers (10) to be transferred from their location and taken to the final storage location.

The blocks of steps (46 and 33) are examples of the payments by the outlet (26) to the owner (28). These payments (46) are applicable for a fixed fee per reusable storage container (10), or alternatively for a percentage of the revenue received, or it may be based on a viable percentage of the volume of rental business transacted.

Generally speaking, and as shown at step (44), the payment received from the customer (28) is based on month to month rental arrangement rates. These rates may be reduced for the customer (28) when they maintain subsequent month rentals, as incentive for loyal longer-term customers (28). As shown at step (45), it is contemplated that the monthly rental rate could drop by a percentage of the original (for instance to a rate that is 25%, or 33% or 50% lower) following the first month, for these longer-term rental arrangements.

The payment received from the individual customer (at step 44) is based on a minimum number of reusable storage containers (10) rented per month and a specific initial minimum monthly rate. Further, the payment received (step 44) is based on a per reusable storage container rental rate. Yet further, the customers (28) may be able to apply a certain amount of their rental to a purchase price should they decided they would rather own the containers (10) while they have them.

It will be understood that the deposit (of step 43) received from the customer (28) is a type of “refundable security deposit” and may, but is not limited to, being in the form of commercial paper (such as an un-deposited check), or the retention of valid credit card information from the customer (28). The purpose of the deposit (step 43) is to cover any expenses at the end of the rental arrangement period regarding damages, late payments, or the like.

As discussed earlier, an optional first step in the system and method of the present invention is for the customer to contact the owner (24). This contact may be made via the telephone or an in-person visit. It should be again noted that the customer (28) can optionally stop directly at one of the outlets (26) or fulfillment centers (25). If the customer desires to set up a rental relationship via telephone, they will simply call the phone number provided in the customer yellow pages, or listed on the owner's web page on the Internet.

Further, for customers (28) that want to move out of town and return the containers in another city, arrangements can be made through a delivery service to pick up the order (if there are not already fulfillment centers (25) or authorized outlets (26) in the new location). These customers may be required to rent the reusable storage containers (10) for a minimum number of months or for a minimum rental dollar amount.

One with ordinary skill in the art will readily recognize that the steps of FIG. 3 (31-52) may be performed sequentially or non-sequentially. Furthermore, the steps may be performed practically all at once or piecemeal.

The containers may be sold rather than rented. Alternatively, customers may be given the option of renting or purchasing the containers. In either case, the containers may be offered for sale, wherein the offer for sale can be coupled with an offer to purchase the container or containers back from the customer at a later time (a buy-back option). The price at which the seller will purchase the container or containers back from the customer may be set at the time of the sale of the container or containers to the customer. Alternatively, the price at which the seller will purchase the container or containers back from the customer may be set at a later date. Any suitable means or timing of calculating the price at which the seller will purchase the container or containers back from the customer is appropriate. After or upon accepting the offer for sale, the customer will pay the purchase price of the container or containers to the seller. The seller will receive the payment and the customer will take possession of the container or containers that the customer purchased.

Where a container or containers has or have been sold to a customer, the customer may later choose to exercise the customer's buy-back option to have the seller purchase the container or container back from the customer for whatever reason. At such a point, the customer may return one or more of the reusable storage containers in the customer's possession to the seller. The seller will then, pursuant to the offer to re-purchase the container or containers that was included in the offer for sale, pay the customer whatever price was or is determined for the re-purchase.

It will be further understood that the rental and distribution steps of the present invention may be performed in the specified manner or in a similar manner of non-specific order.

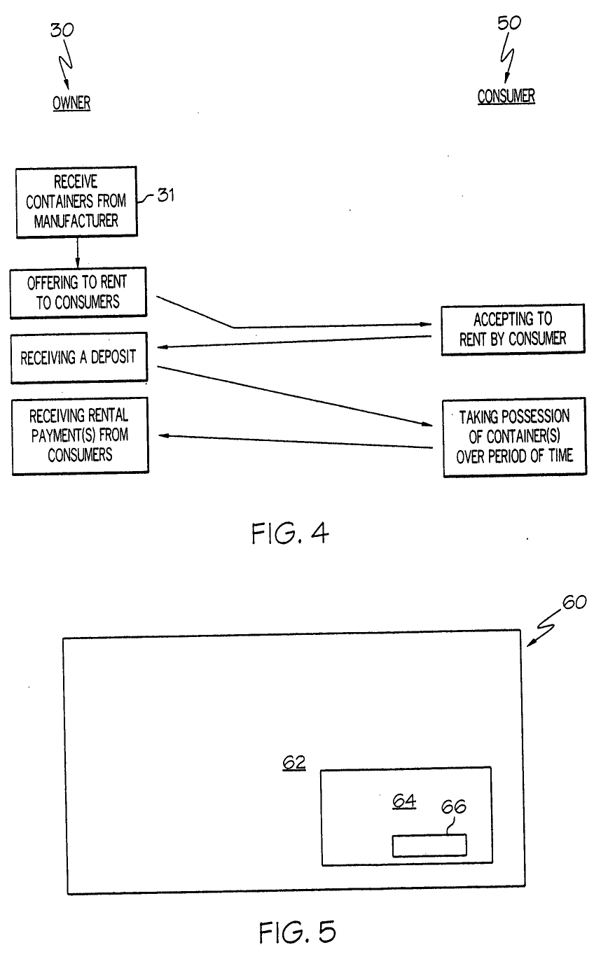

FIG. 5 illustrates an example of a promotion (60) for the rental of reusable storage containers. The promotion (60) could take a variety of forms, including without limitation a physical medium, such as a paper sheet, or online content, such as a web site or e-mail. An advertising portion (62) may include a variety of content, such as photographs of containers, pricing terms, contact information, branding, other products and services, and the like. The promotion (60) in this example includes at least one coupon (64) having a value relating to container rentals. For instance, the value may be a discounted rental price, free containers, upgrades of rental packages, discounted pick-up or delivery rates, and the like. Associated with the coupon (64) is an identifier (66). The identifier (66) can be an alphanumeric code or other way to identify the coupon (64). The identifier (66) could be human readable or machine readable, such as a bar code, magnetic strip, radio frequency identifier, and the like.

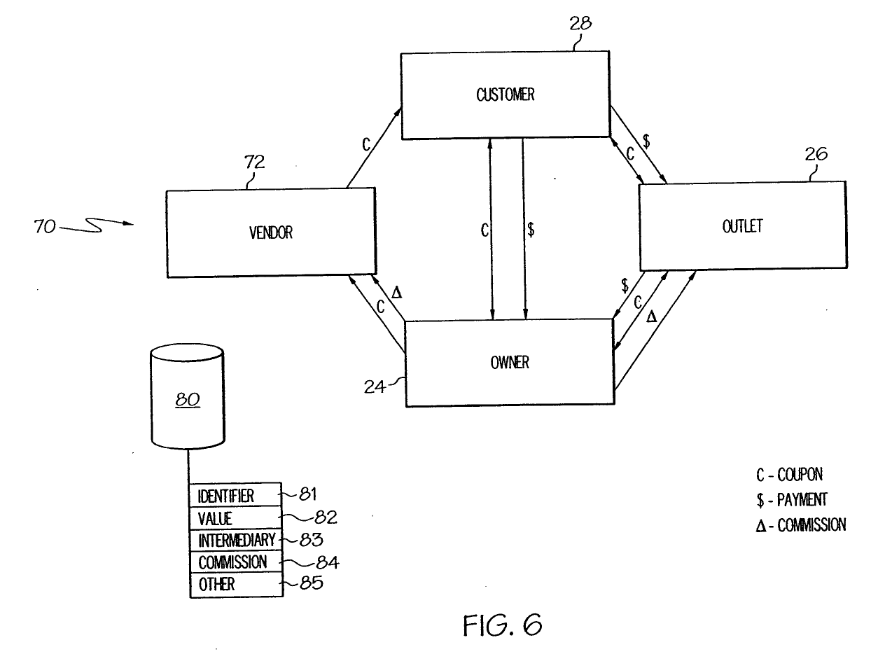

FIG. 6 illustrates some examples of coupon usage options between the owner (24), customer (28), and one or more intermediaries (70). In the present example, the intermediaries (70) include outlets (26) and vendors (72). For the purposes of this example, the difference between the intermediaries (70) is that the outlet (26) can accept rental orders from a customer (28) while a vendor (72) generally will not. A vendor (72) will typically provide goods or services unrelated to reusable storage containers. Some examples of a vendor (72) include, without limitation, real estate agents, home inspectors, carpet or house cleaners, mortgage lenders or brokers, insurance providers, apartment complexes, self-storage facilities, and the like.

The owner (24) can arrange for the coupons to be distributed directly to customers (28), such as through newspaper advertisements, direct mailings, on-line advertising, e-mail solicitations, and the like. The owner (24) can also arrange for coupons to be distributed through intermediaries (70). The intermediary (70) can distribute coupons to customers (28), often free of charge. In some cases, the customer (28) will receive the coupon unconditionally, while in other cases receipt will be conditional, such as conditioned on the customer purchasing the intermediary's (70) goods or services. For example, a landlord could provide all new tenants a coupon for 10 containers free for 30 days. The customer (28) benefits by getting the value of the coupon. The landlord benefits from the transaction by giving a value added incentive to a prospective tenant. The owner (24) benefits from the transaction because tenants may require more than 10 containers, and further because tenants may require containers longer than 30 days. In another example, the intermediary (70) could pre-purchase container rental packages, redeemable with a coupon, and the intermediary (70) could then gift the coupons to its customers (28).

When a customer (28) is ready to rent containers, the customer can redeem the coupons. The rental price will be discounted based on the face value of the coupon. In many cases when a customer (28) redeems a coupon, they will also make a payment. Coupon redemption may include physically transferring the coupon, entering an identifier on-line, telephonically calling in the identifier, scanning the identifier, and the like. The customer (28) can redeem the coupon directly to the owner (24) or to an outlet (26). Outlets (26) will generally accept coupons from customers (28) regardless of where the coupon originated. Thus, the outlet can accept coupons that a customer (28) received from a vendor (72), the owner (24), or a different outlet (24). The outlet (26) will typically transfer all or a portion of the payment and the coupon to the owner (24).

The owner (24) can provide commissions to intermediaries (70). By providing commissions to intermediaries (70), the intermediaries (70) will be more motivated to distribute coupons or otherwise solicit customers (28) for the owner (24). A commission to an intermediary (70) can be triggered upon the redemption of a coupon originating from that intermediary (70). In the case of outlets (26), a commission can be triggered upon receipt of customer orders or customer payments. The commission can be anything of value. For instance, the commission could be a payment of money, either a fixed value or a function of customer orders or payments. In another example, the commission could be more coupons, which may be for free or discounted rental of containers that an intermediary (70) could provide to its customers. In some instances, the commission may be worth more than the value of the coupon, while in other situations, it may be worth the same or less. In one variation, the commission could include significant give-aways (e.g., vacation, TV, stereos, etc.) if the intermediary (70) meets certain threshold rental volume targets, as measured by the redemption of coupons that originated from the intermediary (70).

In another variation, the commission could be the quid pro quo of the owner (24) distributing promotional materials for the intermediary (70). The intermediary's (70) promotional materials could be fliers or coupons placed inside the containers or affixed to the outside of the container. In another variation, the promotional materials could be distributed with customer invoices from the owner (24). Such promotional materials could be distributed only to customers (28) that redeem a coupon associated with the intermediary (70), or to customers unrelated to any coupon redemption. In one variation, the containers associated with a coupon redemption will be prominently branded with the name or logo of the intermediary (70) associated with the redeemed coupon. Optionally, the branding can be done with removable and replaceable signage, which may be particularly useful with walk-in sized containers where the intermediary (70) is, for instance, a self-storage facility.

The datastore (80) can be used to facilitate the use of coupons. Without limitation, some examples of a datastore (80) include computer implemented databases, spread sheets, tables, lists, and the like. The datastore (80) holds information that can be retrieved. In the present example, the datastore (80) includes the following fields: coupon identifier (81), coupon value (82), intermediary (83), commission value (84), and other fields (85), as one may desire. The datastore (80) will generally be fully accessible to the owner (24), and all or portions will be accessible to the intermediaries (70). For example, when a coupon is redeemed, by cross-referencing the identifier (81) with the value (82), the customer will receive the appropriate value. In another example, an intermediary (83) can be associated with an identifier (81), so that when a coupon is redeemed, the originating intermediary (70) will receive an appropriate commission. In one variation, the commission (84) can be associated with the identifier (81) and/or the intermediary (83), so when the correspondence coupon is redeemed, the intermediary (70) is provided the corresponding commission (84).

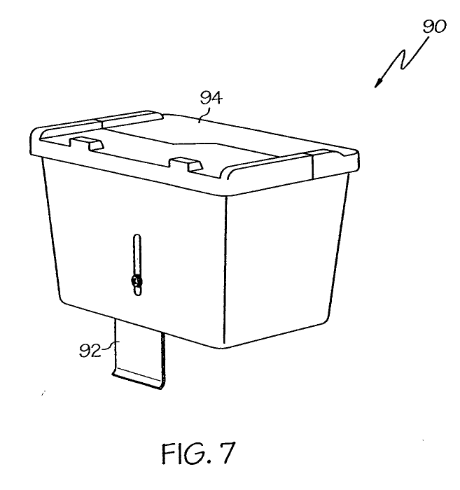

FIG. 7 illustrates an example of a promotional display (90). The display (90) is a container (10), thus providing customers a physical sample of the containers available for renting. The display (90) includes a retractable leg (92) located on the back of the container. The leg (92) tilts the container forward to facilitate viewing the cover (94). Promotional information can be placed on the cover (94), which may include branding for the owner (24) and/or an intermediary (70). The display (90) can be opened, which can hold take-away promotional pieces, including without limitation promotion (60).

Consider an example where a convenient store is the intermediary (70), either as a vendor (72) or as an outlet (26). The convenient store could display the display (90) in the store, which would include a promotion (60). Each coupon would have an identifier associated with the convenient store. When a customer (28) redeems a coupon, the convenient store is paid a monetary commission. Thus, the owner (24) benefits from the advertising and access to retail space, and the convenient store is compensated with commissions.

Consider another example involving a real estate open house. The display (90) can be displayed at an open house. The associated promotional materials will promote that whoever purchases the house will receive a free container rental package, compliments of a vendor (72), which in this example may be a realtor, home inspector, mortgage company, or the like. The owner (24) will sell groups of container rental coupons to the realtor as a vendor (72) at a discount for them to use in the open house giveaway. Often, the coupons will be for free rental of a certain number of containers for a limited period (e.g., 20 small containers for one month). In one variation, the selling price to the vendor (72) can be a substantially discounted (e.g., 50%, 70%, 90% or more off the face value) as a loss leader because customers (28) will often rent additional containers or rent for longer than the coupon period at the normal retail rates. In this example, the discounted selling price to the vendor (72) could be a component of the commission. Thus, the vendor (72) derives the benefit of a low-cost benefit it can provide to customers (28), the owner (24) gets additional dissemination of its offering, and customers (28) enjoy discounted rental rates.

As an optional incentive for the realtors to participate in the open house promotion, the owner (24) may provide for a limited time at no cost to the realtor a coupon (e.g., for a small quantity of boxes, possibly ten for 28 days) to be gifted by the realtor to everyone who tours the open house and signs a guest sheet. After the open house, the realtor would then provide to the owner (24) the guest sheet, which could be used to verify coupons as they are redeemed and monitor realtor participation.

In one variation, a mortgage company could sign up as a vendor (72) and offer, through a realtor's open house, to display a free rental package to anyone who applies for a mortgage. Another intermediary (70) pays the owner (24) to advertise with storage containers, which could offset a discount offered to the mortgage company. When the customer orders (28) or picks up their containers, the intermediary's promotional materials will be placed in the containers or passed out with the owner's invoice.

In another example at a self-storage facility, the owner (24) could provide display samples of smaller containers as well as large outside containers, potentially large enough to walk into. The owner (24) could sell cardboard boxes and packing supplies to the self-storage facility at a discount less than what they are currently paying; in return they become an outlet (26) for the smaller and larger storage containers. When a customer (28) orders walk-in sized containers, the container can be stored at the self-storage facility by the customer, at the owner's warehouse facility, or delivered to the customer's address.

In still another example, the intermediary (72) is an apartment complex. When a tenant is preparing to leave their lease, the complex can send a letter, possibly thanking the tenant for renting at the complex, and the letter could include a container rental coupon. When the tenant redeems the coupon, by tracking the identifier, the complex will be paid a commission, such as a flat-rate price or a percent of the total container rental value purchased by the tenant.

Another example involves fund raising for a charitable organization, such as a school, church, zoo, etc, in which case the organization would be the intermediary (70). Representatives from the organization (e.g., students from the school, parishioners from a church, etc.) can then go door-to-door showcasing to prospective customers (28) the container rental offering of the owner (24). Optionally, such showcasing will be targeted, such as to owners of houses for sale or tenants in apartment complexes. In one variation, the representative can leave coupons with the customers, which once redeemed will result in a commission in the form of a monetary donation from the owner to the organization. In another variation, the organization is paid a commission for each customer who signs a log indicating they were solicited. A higher commission could be provided if the customer provides a telephone number to which the owner (24) could follow up with a call. In yet another variation, coupons are sold to the school for a price less than the face value of the coupon, and representatives of the organization could then resell the coupons to customers or vendors at a higher price, and the organization would keep the difference.

Additional versions herein include a system and method that allows a first provider of goods and/or services, such as a vendor, outlet, intermediary, or owner, to brand coupons with both their identifier and the identifier of a second provider of goods and/or services. This “double branding” may benefit providers of goods and/or services that work in related fields or providers that are otherwise interested in associating their businesses for marketing purposes or any other useful purpose. Coupons for discounted goods and/or services, such as electronic debit cards, may be distributed at little or no cost from a second provider of goods and/or services to a first provider of different goods and/or services. The coupon may bear both provider's identifiers, such as name and picture, and may be distributed by the first provider as, for example, a gift card or as a thank you for services rendered. The second provider may receive the benefit of increased business and/or publicity from the distribution of the coupons and the first provider may benefit from giving clients a “gift” that costs them little or nothing. Additionally, the association of the provider's identifiers may allow each party to benefit from the goodwill associated with the other.

It will be appreciated that the providers of goods and/or services may be from any channel of commerce including, but not limited to, sales, marketing, manufacturing, services, commercial or residential moving, home inspection, architecture, construction, waste disposal, advertising, entertainment, dining, consulting, “do it yourself” products, e-commerce, and professional services. The goods and/or services for which coupons are provided may include, for example, storage containers, discounted moving services, discounted home inspection, discounted entertainment, free meals, discounts at national chains such as WAL-MART or LOWES, or any other product or service which might further the relationship between a provider and a consumer.

Referring back to FIG. 5, versions of the promotion (60) further include promotions for any other suitable goods and/or services such as, for example, discounted moving services, discounted home inspection, discounted entertainment, free meals, discounts at national chains such as WAL-MART or LOWES, or any other suitable product or service. The promotion (60) could take a variety of forms, including without limitation a physical medium, such as a paper sheet or debit card, or online content, such as a web site or e-mail. An advertising portion (62) may include a variety of content, such as photographs of goods and/or services, pricing terms, contact information, trademarks, branding, double branding, other products and services, and the like. The promotion (60) in this example includes at least one coupon (64) having a value relating to any suitable goods and/or services. In one version, the coupon (64) is a debit card having at least one identifier (66). The identifier (66) can be an alphanumeric code, magnetic strip, radio frequency identification tag, a bar code, branding, double branding, and/or any other suitable way to identify the coupon (64). The identifier (66) could be human readable and/or machine readable where, for example, a debit card contains double branding with the names of multiple providers in addition to a magnetic strip identifier. Machine readable identifiers (66) may be operably configured to transmit information to, for example, a database or datastore containing information on coupon amount, the amount of money left on the coupon, the vendor or provider with whom the coupon is associated, and the like. The machine readable identifier (66) may also be modified such that when a portion of the money available on a computer readable debit card has been used, the change will be reflected to the user and/or the database the next time the coupon is used. Coupons (64) may be single use, disposable, re-usable, and/or reloadable with money or the like. Coupons (64) may also be re-brandable after use such that they may be redistributed with the names of different providers, values, offers, contact information, or the like.

Referring again to FIG. 6, disclosed are some examples of coupon usage options between the owner (24), customer (28), and one or more intermediaries (70). In the present example, the intermediaries (70), or first providers, include outlets (26) and vendors (72). For the purposes of this example, the difference between the intermediaries (70) is the outlet (26) can accept rental orders from a customer (28) while a vendor (72) generally will not. Some examples of a vendor (72) include, without limitation, real estate agents, home inspectors, carpet or house cleaners, mortgage lenders or brokers, insurance providers, apartment complexes, self-storage facilities, movers, construction companies, entertainment facilities, national chain retailers, cleaning services, waste disposal services, or the like.

The owner, or second provider, (24) can arrange for the coupons to be distributed directly to customers (28), such as through newspaper advertisements, direct mailings, on-line advertising, e-mail solicitations, and the like. The owner (24) can also arrange for coupons to be distributed through intermediaries (70). The intermediary (70) can distribute coupons to customers (28), often free of charge. In some cases, the customer (28) will receive the coupon unconditionally, while in other cases receipt will be conditional, such as conditioned on the customer purchasing the intermediary's (70) goods or services. For example, a landlord could provide all new tenants a coupon for a five dollar discount from a local restaurant. The customer (28) benefits by getting the value of the coupon. The landlord benefits from the transaction by giving a value added incentive to a prospective tenant. The owner (24) benefits from the transaction because tenants may continue to frequent their restaurant and/or may spend more than the face value of the coupon. In another example, the intermediary (70) could pre-purchase various goods and/or services, redeemable with a coupon, and the intermediary (70) could then gift the coupons to its customers (28).

When a customer (28) is ready to redeem the coupon (64), they may physically transfer a coupon, swipe a gift or debit card, enter an advertising code on-line, scan the identifier (66), telephonically call in the coupon, or the like. The customer (28) can redeem the coupon directly to, for example, the owner (24) or to an outlet (26). Outlets (26) will generally accept coupons from customers (28) regardless of where the coupon originated. Thus, the outlet can accept coupons that a customer (28) received from a vendor (72), the owner (24), a different outlet (24), or any other suitable provider. The outlet (26) may transfer all or a portion of the payment and the coupon to the owner (24).

The owner (24) can provide commissions to intermediaries (70). By providing commissions to intermediaries (70), the intermediaries (70) will be more motivated to distribute coupons or otherwise solicit customers (28) for the owner (24). A commission to an intermediary (70) can be triggered upon the redemption of a coupon originating from that intermediary (70). In the case of outlets (26), a commission can be triggered upon receipt of customer orders or customer payments. The commission can be anything of value. For instance, the commission could be a payment of money, either a fixed value or a function of customer orders or payments. In another example, the commission could be more coupons, which may be for free or discounted goods and/or services that an intermediary (70) could provide to its customers. In some instances, the commission may be worth more than the value of the coupon, while in other situations, it may be worth the same or less. In one variation, the commission could include significant give-aways (e.g., vacation, TV, stereos, etc.) if the intermediary (70) meets certain threshold rental volume targets, as measured by the redemption of coupon (64) that originated from the intermediary (70).

In another variation, the commission could be the quid pro quo of the owner (24) distributing promotional materials for the intermediary (70). The intermediary's (70) promotional materials could be fliers or coupons placed inside the goods or distributed with the services. In another variation, the promotional materials could be distributed with customer invoices from the owner (24). Such promotional materials could be distributed only to customers (28) that redeem a coupon associated with the intermediary (70), or to customers unrelated to any coupon redemption. In one variation, the goods and/or services associated with a coupon redemption will be prominently branded with the name or logo of the intermediary (70), or first provider, associated with the redeemed coupon. Optionally, the goods and services may include “double branding” where the name or identifier of both the owner and the intermediary is displayed prominently.

The datastore (80) may be used to facilitate the use of coupons. Without limitation, some examples of a datastore (80) include computer implemented databases, debit accounts, spread sheets, tables, lists, and the like. The datastore (80) holds information that can be retrieved. In one version, the datastore (80) includes the following fields: coupon identifier (81), coupon value (82), intermediary (83), commission value (84), the available value of the coupon, and the expended value of the coupon, and/or other fields (85) as one may desire. The datastore (80) will generally be fully accessible to the owner (24) with all or portions accessible to the intermediaries (70). For example, when a coupon is redeemed, by cross-referencing the identifier (81) with the value (82), the customer will receive the appropriate value. In another example, an intermediary (83) can be associated with an identifier (81), so when a coupon is redeemed, the originating intermediary (70) will receive an appropriate commission. In one variation, the commission (84) can be associated with the identifier (81) and/or the intermediary (83), so when the correspondence coupon is redeemed, the intermediary (70) is provided the corresponding commission (84).

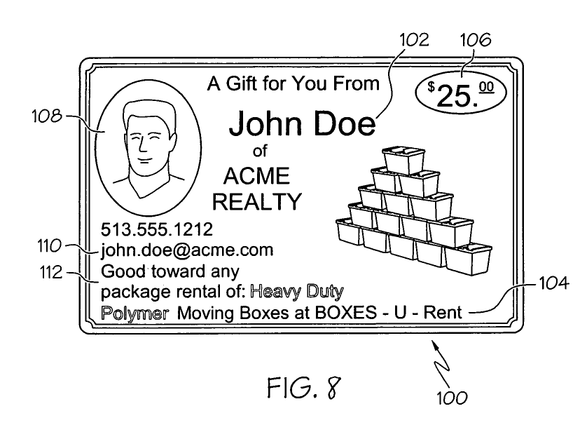

FIG. 8 illustrates one example of a coupon (100) having a first identifier (102) and a second identifier (104) “double branded” thereon. Double branding is herein defined as inscribing or otherwise providing a coupon with indicators of at least two entities. Double branding may benefit providers of goods and/or services that work in related fields or providers that are otherwise interested in associating their businesses. The first provider, who may inscribe their source indicator at first identifier (102) may benefit from giving clients a “gift” that costs them little or nothing. The second provider, who may inscribe their source indicator at second identifier (104), may receive the benefit of increased business and/or publicity from the distribution of the coupons to the first provider. Additionally, the association of the provider's identifiers may allow each party to benefit from the goodwill associated with the other. It will be appreciated that any suitable number of identifiers may be present on a coupon (100) where, for example, three parties may wish to enter into an arrangement where the coupon is triple-branded.

The coupon (100) may additionally include an indicator of value (106) which may disclose the monetary or service value of the coupon (100) to the consumer. The provider's contact information (110), picture or logo (108), the offer (112) represented by the coupon (100), or any other useful information may also be displayed. The coupon (100) may also include a magnetic strip, radio frequency identification tag, bar code, or the like that may automatically be read for determination of coupon (100) value or for redemption purposes. The coupons (100), for example, may be distributed to customers by an intermediary (70), or first provider, and may be redeemed at the business of the second provider, such as a national retail chain.

For example, a moving company may enter into a business relationship with a national hardware retailer for the benefit of both parties. The retailer may agree to supply coupons (100) to the moving company for discounted hardware at no cost to the moving company. After completing a moving job, the moving company may distribute the coupons (100) to the consumer which may be in the form of a debit card redeemable at the national hardware retailer. In this way, the moving company may benefit from giving consumers a free gift and the national retailer may benefit from publicity and increased business. The association of the two parties may also indicate to consumers that each is reputable and that there is shared goodwill between the goods and/or service providers.

It is evident that many alternatives, modifications, and variations of the present invention will be apparent to those skilled in the art in light of the foregoing teachings. Accordingly, the invention is intended to embrace all such alternatives, modifications and variations as may fall within the spirit and scope of the appended claims.

What is claimed is:

1. A method for marketing, comprising:
a) providing a coupon having;
(i) a first identifier for a first provider,
(ii) a second identifier for a second provider, and
(ii) a third identifier, wherein said third identifier communicates with a datastore;
b) distributing said coupon to a consumer;
c) receiving from said consumer a request to redeem said coupon;
d) communicating with said datastore upon receiving a request from said consumer; and
e) providing value to said consumer for redeeming said coupon.

2. The method of claim 1, wherein said first provider is selected from the group consisting of intermediaries, vendors, outlets, and owners.

3. The method of claim 1, wherein said first provider is selected from the group consisting of movers, restaurants, construction companies, real estate agents, home inspectors, carpet cleaners, house cleaners, mortgage lenders, mortgage brokers, insurance brokers, apartment complexes, retail chains, retailers, and self-storage facilities.

4. The method of claim 1, wherein said second provider is selected from the group consisting of intermediaries, vendors, outlets, and owners.

5. The method of claim 1, wherein said owners are selected from the group consisting of movers, restaurants, construction companies, real estate agents, home inspectors, carpet cleaners, house cleaners, mortgage lenders, mortgage brokers, insurance providers, apartment complexes, retail chains, retailers, and self-storage facilities.

6. The method of claim 1, wherein said coupon is for a discount on goods.

7. The method of claim 6, wherein said first provider pays for said coupon.

8. The method of claim 6, wherein said second provider freely gives said coupon to said first provider.

9. The method of claim 1, wherein said coupon is for a discount on services.

10. The method of claim 9, wherein said first provider pays for said coupon.

11. The method of claim 9, wherein said second provider freely gives said coupon to said first provider.

12. A method for marketing, comprising:
a) offering goods in exchange for a payment of money;
b) advertising said goods with a coupon indicating a first provider and a second provider; and
c) providing a commission to said first provider based on a customer's ordering goods from said second provider and redeeming said coupon.

13. The method of claim 12, wherein said coupon includes an identifier that redeems said coupon electronically when a customer requests redemption.

14. The method of claim 12, wherein said commission is money.

15. The method of claim 12, wherein said commission is additional free coupons.

16. A method for marketing, comprising:
a) offering services in exchange for a payment of money;
b) advertising said services with a coupon indicating a first provider and a second provider; and
c) providing a commission to said first provider based on a customer's ordering services from said second provider and redeeming said coupon.

17. The method of claim 16, wherein said coupon includes an identifier that redeems said coupon electronically when a customer requests redemption.

18. The method of claim 16, wherein said commission is money.

19. The method of claim 16, wherein said commission is additional free coupons.
